(19) United States
(12) Patent Application Publication
(10) Pub. No.: US 2005/0093998 A1
(43) Pub. Date: May 5, 2005

(54) Digital camera with variable size delete buffer

(76) Inventors: William R. Haas, Fort Collins, CO (US); Kirk S. Tecu, Greeley, CO (US); James S. Voss, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,708

(22) Filed: Nov. 3, 2003

(51) Int. Cl. H04N 5/76; G06F 12/14; G06F 13/28; G06F 12/00; G06F 12/16

(52) U.S. Cl. 348/231.2; 711/147

(57) ABSTRACT

A digital camera and method that provide the ability to dynamically partition memory (both internal and removable) into memory dedicated for saved images and memory dedicated for deleted images. Deleted images may occupy as much memory as is available down to a user or factory selectable minimum. When a user deletes an image it is moved from a saved memory partion into a deleted memory partition, and when the memory partition dedicated to deleted images is full, then images are automatically and permanently deleted. In a preferred embodiment, the deleted images are automatically and permanently deleted on a first-in first-deleted basis. The deleted memory partition may be a physical memory partition or may correspond to indexed memory locations of the deleted images.

### TECHNICAL FIELD

The present invention relates generally to digital cameras, and more specifically, to a digital camera having a variable size delete buffer.

### BACKGROUND

The assignee of the present invention develops digital cameras, and the like. Such digital cameras may be used to record still images and full motion video images.

Currently, deleting images stored in a digital camera is a two-step process, wherein the second step is a confirmation step. This prior art image deletion process is unnecessarily time consuming. It would be desirable to have a one step image deletion process.

By way of background, U.S. Pat. Nos. 5,633,678 and 6,512,548 discuss the use of image buffers in digital cameras. U.S. Pat. No. 5,633,678 indicates that “digital image data is applied to an image buffer 18 for storing one or more images”, and the use of “an image delete icon 52f”. U.S. Pat. No. 6,512,548 discloses the use of a “delete button” and that the “user may also have the full-sized image displayed of a chosen image and can delete the image.” However, neither of these patents discloses or suggests the use of a variable size delete buffer, or partitioning memory to provide for saved and deleted image memory partitions.

One aspect of the present invention is to provide for an improved digital camera having a variable size delete buffer.

### SUMMARY OF THE INVENTION

An embodiment of the present invention provides for a digital camera having the ability to dynamically partition memory (both internal and removable) into memory dedicated to saved images and deleted images. Deleted images may occupy as much memory as is available down to a user or factory selectable minimum. When a user deletes an image it is moved into a deleted memory partition, and when the memory partition dedicated to deleted images is full, then images are automatically and permanently deleted, and in a preferred embodiment, on a first-in first-deleted basis. The deleted memory partition may be a physical memory partition or may correspond to indexed memory locations of the deleted images.

By providing a deleted image memory partition, the image deletion process is a one step process, since images accidentally deleted can be easily recovered from the deleted image partition. The present invention solves the problem of reducing the time required to delete unwanted images.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are front and back views, respectively, that illustrate an exemplary embodiment of a digital camera employing a variable size delete buffer in accordance with the principles of the present invention; and

FIG. 2 is a flow diagram that illustrates an exemplary method in accordance with the principles of the present invention.

### DETAILED DESCRIPTION

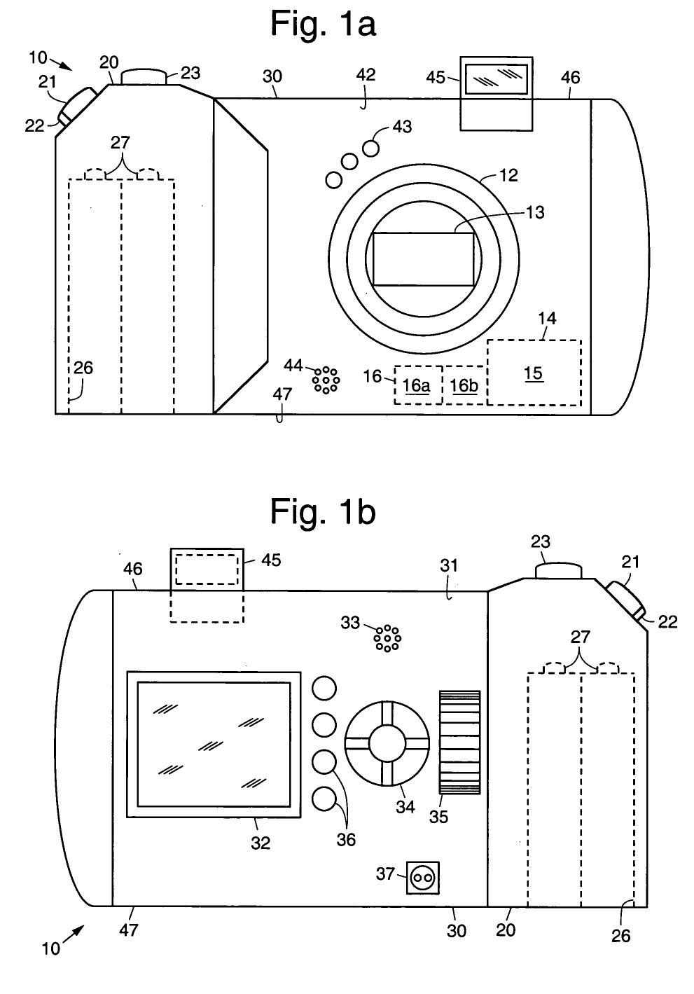

Referring to the drawing figures, FIGS. 1a and 1b show front and back views, respectively, that illustrate an exemplary embodiment of a digital camera 10 in accordance with the principles of the present invention. The exemplary digital camera 10 implements a variable size delete buffer 11 in accordance with the principles of the present invention.

The exemplary digital camera 10 comprises a handgrip section 20 and a body section 30. The handgrip section 20 includes a power button 21 having a lock latch 22, a shutter button or record button 23, and a battery compartment 26 for housing batteries 27. A metering element 43 and microphone 44 are disposed on a front surface 42 of the digital camera 10. A pop-up flash 45 is located adjacent the top surface 46 of the digital camera 10.

As is shown in FIG. 1b, a rear surface 31 of the exemplary digital camera 10 includes a liquid crystal display (LCD) 32, a rear microphone 33, a joystick pad 34, a zoom control-dial 35, a plurality of buttons 36 for setting functions of the camera 10 and an output port 37 for downloading images to an external display device or computer, for example.

The digital camera 10 also comprises a lens or imaging optics 12, and an image sensor 13 for receiving optical images transmitted by the imaging optics 12 and capturing digital images thereof. A processor 14 is coupled to the image sensor 13 (and other control and input/output components). The processor 14 is also coupled to image memory 16, which may include internal memory and removable memory.

The processor 14 comprises a partitioning algorithm 15 that dynamically partitions the available memory 16 in the camera 10. The partitioning algorithm 15 is used to configure the amount of memory 15 that is available to store saved and deleted images. Captured images are stored in a saved image memory partition 16a, and deleted images are stored in a deleted image memory partition 16b.

The user selects a desired amount of deleted image memory or uses a factory-preset minimum for the deleted image memory partition 16b. Images that are taken by the user are automatically stored in the available image memory 16, specifically in the saved image memory partition 16a.

When the user deletes an image, it is moved into the deleted image memory partition 16b. Alternatively, the memory locations of the deleted image are identified as “deleted memory locations”, corresponding to the deleted image memory partition 16b.

When the memory partition dedicated to deleted images (i.e., the deleted memory partition 16b) is full, the deleted images are automatically and permanently deleted on a first-in first-deleted basis.

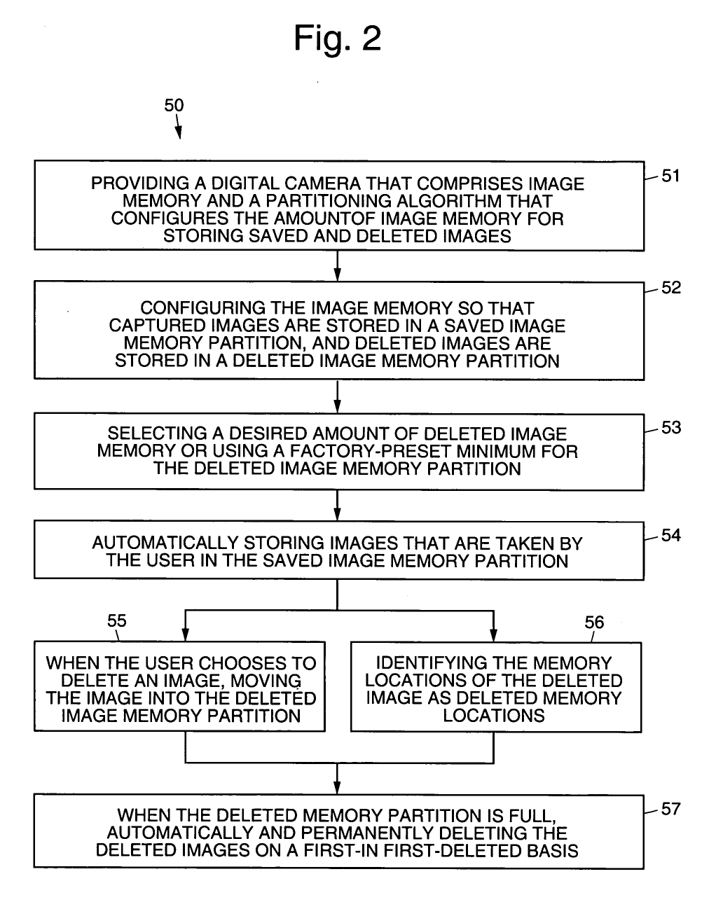

FIG. 2 is a flow diagram that illustrates an exemplary method 50 in accordance with the principles of the present invention. The exemplary method 50 comprises the following steps.

A digital camera 10 is provided 51 that comprises image memory 16 and a partitioning algorithm 15 that configures the amount of image memory 16 for storing saved and deleted images. The image memory 16 is configured 52 so that captured images are stored in a saved image memory partition 16a, and deleted images are stored in a deleted image memory partition 16b.

The user selects 53 a desired amount of deleted image memory or uses a factory-preset minimum for the deleted image memory partition 16b. Images that are taken by the user are automatically stored 54 in the available image memory 16, specifically in the saved image memory partition 16a. When the user chooses to delete an image, it is moved 55 into the deleted image memory partition 16b. Alternatively, the memory locations of the deleted image are identified 56 as deleted memory locations, corresponding to the deleted image memory partition 16b. When the deleted memory partition 16b is full, the deleted images are automatically and permanently deleted 57 on a first-in first-deleted basis.

Thus, an improved digital camera having a variable size delete buffer and method have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A digital camera comprising:
an image sensor for capturing digital images;
image memory for storing captured images; and
a processor coupled to the image sensor and image memory that comprises a partitioning algorithm that dynamically partitions the image memory so that captured images are stored in a saved image memory partition, and deleted images are stored in a deleted image memory partition.

2. The digital camera recited in claim 1 wherein the image memory comprises internal memory.

3. The digital camera recited in claim 1 wherein the image memory comprises removable memory.

4. The digital camera recited in claim 1 wherein the image memory comprises internal memory and removable memory.

5. The digital camera recited in claim 1 wherein the deleted image memory partition is selected by a user.

6. The digital camera recited in claim 1 wherein the deleted image memory partition comprises a factory-preset minimum.

7. The digital camera recited in claim 1 wherein when a stored image is deleted from the saved image memory partition, it is moved into the deleted image memory partition.

8. The digital camera recited in claim 1 wherein when a stored image is deleted from the saved image memory partition, memory locations of the deleted image are identified as deleted memory locations.

9. The digital camera recited in claim 1 wherein when the deleted memory partition is full, the deleted images are automatically and permanently deleted on a first-in first-deleted basis.

10. A method comprising the steps of:
providing a digital camera comprising an image sensor for capturing digital images, image memory for storing captured images, and a processor coupled to the image sensor and image memory that comprises a partitioning algorithm;
configuring the image memory into a saved image memory partition and a deleted image memory partition;
selecting a desired amount of deleted image memory;
storing captured images in the saved image memory partition; and
when the user deletes an image, moving it from the saved image memory partition into the deleted image memory partition.

11. The method recited in claim 10 wherein the step of selecting a desired amount of deleted image memory comprises using a factory-preset minimum.

12. The method recited in claim 10 wherein when the deleted memory partition is full, automatically and permanently deleting the deleted images on a first-in first-deleted basis.

13. The method recited in claim 10 wherein the image memory comprises internal memory.

14. The method recited in claim 10 wherein the image memory comprises removable memory.

15. The method recited in claim 10 wherein the image memory comprises internal memory and removable memory.

16. The method recited in claim 10 wherein the the step of selecting a desired amount of deleted image memory is selected by a user.

17. A method comprising the steps of:
providing a digital camera comprising an image sensor for capturing digital images, image memory for storing captured images, and a processor coupled to the image sensor and image memory that comprises a partitioning algorithm;
configuring the image memory into a saved image memory partition and a deleted image memory partition;
selecting a desired amount of deleted image memory;
storing captured images in the saved image memory partition; and
when the user deletes an image, identifying the memory locations of the deleted image as deleted memory locations.

18. The method recited in claim 17 wherein the step of selecting a desired amount of deleted image memory comprises using a factory-preset minimum.

19. The method recited in claim 17 wherein when the deleted memory partition is full, automatically and permanently deleting the deleted images on a first-in first-deleted basis.

20. The method recited in claim 17 wherein the image memory comprises internal memory.

21. The method recited in claim 17 wherein the image memory comprises removable memory.

22. The method recited in claim 17 wherein the image memory comprises internal memory and removable memory.

23. The method recited in claim 17 wherein the the step of selecting a desired amount of deleted image memory is selected by a user.
